(19) United States
(12) Patent Application Publication
(10) Pub. No.: US 2015/0284583 A1
(43) Pub. Date: Oct. 8, 2015

(54) HYDROPHOBING DISPERSION GEL HAVING REDUCED ACTIVE INGREDIENT CONTENT, METHOD FOR THE PRODUCTION THEREOF, AND USE THEREOF FOR THE HYDROPHOBING OF MINERAL MATERIALS

(71) Applicant: Ionys AG, Karlsruhe (DE)

(72) Inventors: Andreas Gerdes, Karlsruhe (DE); Detlef Ballschuh, Berlin (DE); Horst Seibt, Berlin (DE)

(21) Appl. No.: 14/417,824

(22) PCT Filed: Jul. 24, 2013
(86) PCT No.: PCT/EP2013/065608

§ 371 Date: Jan. 28, 2015

(30) Foreign Application Priority Data
Jul. 30, 2012 (DE) 10 2012 106 887.9

(51) Int. Cl. C09D 133/02

(52) U.S. Cl. CPC C09D 133/02; C08K 5/32

(57) ABSTRACT

The present invention relates to a hydrophobizing dispersion gel having reduced active substance content, comprising relative to a total quantity of 100 wt. % the components:

(A) 0.1-less than 50 wt. % alkyltrialkoxysilane,

(B) 0.1-1.0 wt. % branched polyacrylic acid

(C) 0.5-2.0 wt. % trialkyl-amine-N-oxide,

(D) 3.0-10 wt. % non-ionic tenside and

(E) 10-80 wt. % water.

The invention further relates to a method for producing the hydrophobizing dispersion gel and its use for hydrophobizing mineral materials.

The present invention relates to a hydrophobizing dispersion gel with reduced active substance content and a method for producing the hydrophobizing dispersion gel as well as its use for hydrophobizing mineral materials.

Cement-bound materials such as, for example, reinforced concrete, which are found in concrete buildings are exposed to various environmental influences dependent on the use. Of particular importance for the functionality and durability of these materials and the components and buildings manufactured from these is the resistance to the uptake of aqueous salt solutions such as, for example, de-icing salts. The commercially available de-icing salt consists for the most part of cooking salt or rock salt, i.e. sodium chloride (NaCl). Contact of concrete components with these aqueous chloride solutions has the result that these are transported into the material edge zone by capillary suction. If the chlorides reach the steel reinforcement, under certain conditions corrosion processes may be triggered which can result in loss of stability.

In order to prevent these transport processes, it is known to make the material edge zone water-repellent (hydrophobic) with silicon organic compounds, so-called alkyltrialkoxysilanes (silanes). This results in an impregnating effect with respect to water or electrolytes dissolved in the water such as, for example de-icing salts. Hydrophobization or hydrophobizing impregnation means a treatment of the concrete to produce a water-repellent edge zone. The pores and capillaries in the edge zone are only lined but not filled. No closed film is formed on the surface of the concrete. The external appearance changes little or not at all in this case.

Under normal climatic conditions a thin water film forms on the inner surfaces of the capillaries of cement-bound materials or the pores are filled with an alkaline solution (pore solution). The silanes are applied undiluted or in the form of aqueous systems to the material surface. From there they are transported into the material edge zone (see FIG. 1).

During transport complex chemical reactions take place where in principle two partial steps can be distinguished. In the first step a solvolysis (hydrolysis) R*Si(OR)₃+H₂O→R*Si(OH)₃+3ROH takes place, which is accompanied by the formation of silanols and alcohol, for example ethanol (see FIG. 2).

The water-soluble reaction products (silanol, alcohol) migrate through the silane/water film interface. As a result of their chemical structure, these components reduce the interfacial tension and therefore also influence the transport of the silanes. This means that the chemical reactions influence the transport and the transport influences the chemical reactions by forming local equilibria (reactive transport). In a second step the silanols react with one another or with the terminal OH groups of the CSH gel (calcium silicate hydrate in colloidal form) which substantially builds up the cement stone. These reactions result in the formation of a thin, hydrophobically acting silicone resin film (polysiloxane) on the inner surfaces of the cement-bound material (see FIG. 3).

Overall hydrophobization is a generally acknowledged efficient surface protection for reinforced concrete buildings stressed by moisture and the pollutants contained therein (see Regulations of the German Committee for Reinforced Concrete (DAfStb) DIN EN 1504-9 Products and systems for the protection and maintenance of concrete supporting structures—definitions, requirements, quality monitoring and assessment of conformity—Part 9: General principles for the application of products and systems; German version EN 1504-9:2008, date published: 2008-11, Beuth-Verlag, Berlin, DAfStb-Guideline—Protection and maintenance of concrete components (maintenance guideline)—Part 1: General regulations and planning principles; Part 2: Building products and application; Part 3: Requirements for operations and monitoring of the design; Part 4: Test methods, Beuth-Verlag, date published: 2001-10, Beuth-Verlag, Berlin).

The efficiency and durability of a hydrophobization depends crucially on the penetration depth and the active substance content in the material edge zone. Both are in turn determined by the contact time between the silane and the porous material or by the course of the reactive transport. In conventional products based on an undiluted silane (100% silane) the contact time is only very short since this runs down as a low-viscosity liquid on the material surface or vaporizes rapidly due to the high volatility under practical conditions (e.g. surface temperatures up to about 70° C.). Penetration depths of more than 2 mm cannot be achieved in a practical application (A. Gerdes, Transport and chemical reaction of silicon organic compounds in the concrete edge zone, Building Materials Report No 15, AEDIFICATIO Verlag, Freiburg i. B., (2001)).

A number of means comprising individual or different, frequently including polymeric, organosilicon compounds are known for the impregnation, hydrophobization or deep hydrophobization of porous building materials, concrete buildings and reinforced concrete structures. These means are present in the form of aqueous emulsions, creams, gels or compositions containing mineral thickening agents.

In order to avoid the use of organic solvents but at the same time reduce the fraction of active substance (silane), low-viscosity aqueous systems, so-called emulsions, have been developed. For example, the emulsion described in the European Patent EP 0 538 555 B1 contains alkoxysilanes, silane tensides, buffering substances and optionally anionic tensides (Degussa). A disadvantage with these low-viscosity emulsions is a too-short contact time or lifetime, for example on vertical building surfaces or bridge underparts and similar surfaces. The active substance in the preparation requires a certain time to penetrate into the mineral building material subsurface. The emulsion runs off or drips off too rapidly or is lost to the surroundings through evaporation. It was also confirmed by studies that the emulsions in young concrete break up after a short time. The water present in excess as solvent then penetrates into the material and blocks the pore space for the silane. With various formulations, penetration depths of more than 2 mm could not be achieved despite repeated application under practical conditions, not even in suction experiments in the laboratory (A. Gerdes and F. H. Wittmann, Hydrophobization of reinforced concrete—Part 1: Transport and chemical reactions of silicon-organic compounds in the concrete edge zone, Int. Z. Bauinstandsetzen, 9, 41-64 (2003)). In addition to the low penetration depth, it is found to be a further disadvantage that only an inadequate hydrophobizing performance is achieved. The consequence is a necessary repetition of the procedure. During a repetition however, hardly any/no transport occurs since an aqueous system is now present on a hydrophobic surface. Such after treatments are costly and furthermore waste valuable raw materials.

Subsequently high-viscosity water-containing systems were developed to significantly lengthen the contact time. One of these products is of the type of “cream” disclosed in the European Patent EP 1 154 971 B1 (Wacker A G). The aqueous stable cream is used for hydrophobizing building materials by applying this to the surfaces of mineral materials or using this as binder (added directly to the fresh mortar) and primer in building coatings. Used as the main components of the cream are C₁-C₂₀-alkyl-C₂-C₆ alkoxysilanes, organo(poly)siloxanes containing alkoxy groups, alkyl polyglycol ether or polyvinyl alcohol as non-ionic emulsifier and 1 to 95 weight % of organic solvent such as alkanes, gasoline hydrocarbons, longer-chain alcohols and ethers. In addition, the cream contains as an additive hydrophobized highly disperse silicic acid.

A disadvantage with the use of such cream compositions is that the deep migration of the active substance components is too low. In particular, cream emulsions tend to fracture too rapidly on the surface, i.e. aqueous and organic phases separate. This applies particularly for young materials since in these the alkalinity is still maintained. The penetrating water has the effect that the pore space becomes at least partially blocked. This prevents transport of the active substance into deeper regions of the material edge zone, i.e. a penetration depth of >3 mm can only be achieved under practical conditions in a few cases. According to practical experience, the maximum quantities which can be applied here are 400 g/m² since otherwise slipping off occurs. Accordingly the actual aim of deep migration is not achieved although such creams have higher contact times as a result of their consistency. However, the penetration depths of up to 3 mm that are achieved therewith are not sufficient to prevent the breakthrough of the salt solution through the hydrophobized edge zone in the long term under very high stressing (e.g. ports, bridge structures, underground garages), as studies have shown (A. Gerdes and Z. Huang, On the application of hydrophobizations for the protection of “off-shore” structures, Int. Z. Bauinstandsetzen, 9, 293-306 (2004)).

Higher penetration depths of 4-6 mm can be achieved with high-viscosity anhydrous products (“gel”). In the European Patent Specification EP 0 751 922 B1 (Karlsson) an anhydrous gel and a method for treating in particular concrete buildings with a hydrophobizing substance is described (silanes/siloxanes, in part isobutyl triethoxysilane and ethanol as polar solvent).

The gel-like composition consists of the hydrophobizing substance, substantially of solvent-free silanes/siloxanes and a carrier medium which is an organophilic layer-lattice mineral with swelling behaviour such as bentonite or montmorrillonite. Due to capillary action the hydrophobizing substance penetrates into the mineral materials to be treated whilst the carrier medium remains on the surface. These gel-like anhydrous compositions with organophilic layer-lattice minerals such as bentonite as gel forming agent allow the active substance to penetrate deeper into the material edge zone as a result of longer contact times but also exhibit additional application deficiencies of a different type. Since the gel forming agent as a mineral solid cannot penetrate into the treatment surface, it leaves undesired discolorations there, which is problematical for example for visible concrete surfaces. On the other hand, a considerable fraction of the active substance remains unused in the organophilic layer-lattice mineral, which is therefore lost for the application and in addition passes in an uncontrolled manner into the surroundings. Also the consumption of 800-1000 g/m² in order to achieve a penetration depth of at least 6 mm is relatively high, especially as the silane content is about 90%.

In addition to the formulation of surface protection systems which are only based on the use of silicon organic compounds, combination products have also been developed. Thus Degussa AG describes in the European Patent Application EP 1 308 428 A2 an aqueous emulsion based on silicon organic compounds and a method for protecting reinforced concrete from corrosion of the steel reinforcement. The agent is either applied to a reinforced concrete surface or added to the concrete during the manufacturing process. The aqueous emulsion contains, in addition to at least one organosilane or organosiloxane or particle condensates thereof, also aminoalkyl silanes or siloxanes, alkaline earth salts of dinonylnaphthalene sulfonic acid as well as amino alcohols, such as dimethylaminoethanol or diethylaminoethanol. The agent also contains as additional components diisotridecyladipate, mineral oil, gasoline hydrocarbons, alcohols, water, emulsifiers, rheological adjuvants and thickening adjuvants. During the subsequent application, the emulsion is for example applied to the concrete surface by spreading in a quantity of more than 50 g/m²to more than 200 g/m². With regard to the penetration depth and therefore the efficiency of this system, however there are considerable doubts since for protection against corrosion the corresponding active substance must reach the reinforcement. The moisture distribution in solid components which are exposed to the environment can be given as the reason for this. On the contrary non-uniform reinforcement coverings can result in an increase in the corrosion risk as a result of the formation of local elements. As a result of the interaction between the cement stone phase and the chemical compounds (sorption) as well as the moisture distribution to be expected under real conditions in the concrete edge zone (high water saturation at a distance of about 1-2 cm), no high penetration depths can be expected.

Overall all the hitherto known systems exhibit deficiencies such as material losses or high material costs (necessary multiple application) and in particular too low contact times and too low penetration depths as well as at least unsightly residues remaining on the treated surfaces. Even gel and cream compositions which yield longer contact times with greater penetration depths as a result of their consistency, do not enable any deep migration of the active substance components or only enable this with a disproportionately high material expenditure.

The requirements for products and systems for the protection and maintenance of concrete support structures are regulated in the standard EN 1504 (in Germany DIN EN 1504) . With regard to hydrophobization, a distinction is made between classes I and II where class 1 is characterized by a penetration depth of <10 mm and class II is characterized by a penetration depth of the hydrophobizing agent of ≧10 mm.

Such penetration depths however depend strongly on the condition of the material, primarily on the porosity and the water saturation. The permeability of the concrete increases exponentially with the water cement value W/Z value. The W/Z value for reinforced concrete is generally between 0.4 and 0.6. The concrete required for the tests according to EN 1504 with a W/Z value of 0.7 is however significantly more porous and absorbent than the usual concretes in practice (En 1504-2: Products and systems for the protection and maintenance of concrete supporting structures—definitions, requirements, quality monitoring and assessment of conformity—Part 2: Surface protection systems for concrete; date published: 2005-01, Beuth-Verlag, Berlin)).

To compensate for these deviations, subsequently a deep hydrophobization is understood as an effective penetration depth of ≧6 mm. “Effective penetration depth” means that sufficient active substance is present in the corresponding depth of the treated material to reduce capillary suction by more than 90% compared to untreated material. For this a silane-dependent minimum active substance content is required. For a product based on isooctyltriethoxysilane at least 3 mg of the final polysiloxane per gram of concrete is required for this purpose in the corresponding depth. This can be applied similarly to other silanes or resulting polysiloxanes.

Deep hydrophobization is particularly required for structures which are particularly exposed, for example, harbours or bridge pillars. In other applications, for example in abutments of bridges which are at a greater distance from the road, lower penetration depths (3-4 mm) and lower active substance contents are sufficient in the corresponding depth (≧2 mg/g of concrete).

The German Patent Application DE 10 2011 003 975.9 (filing date 11.02.2011), which also relates to a hydrophobizing gel, also originates from the inventors of the present application. This gel has in relation to a total quantity of 100 wt. % the components:
(A) 50-80 wt. % alkyltrialkoxysilane,
(B) 0.3-1.0 wt. % branched polyacrylic acid,
(C) 0.5-2.0 wt. % non-tensidic amine oxide,
(D) 0.2-1.0 wt. % tensidic amine oxide,
(E) 5.0-12 wt. % non-ionic tenside and
(F) 8.0-40 wt. % water.

In this invention it was assumed that an alkyltrialkoxysilane content of more than 50 wt. % is absolutely necessary to obtain stable systems with adequate penetration depth. Corresponding systems having a lower alkyltrialkoxysilane content yielded inadequate penetration depths and proved unstable. For the stabilization of these systems it was furthermore absolutely essential to use a combination of tensidic (component C) and non-tensidic (component D) amine oxide. An amine oxide is understood as a trialkyl-amine-N-oxide. Both terms are used synonymously subsequently. These systems of DE 10 2011 003 975.9 are particularly suitable for deep hydrophobizing and are therefore extremely well suited for the treatment of structures which are particularly exposed (e.g. harbours or bridge pillars).

Such a high content of 50 or more wt. % of alkyltrialkoxysilane is however economically highly undesirable as a result of the costs, especially as penetration depths of >6 mm are only required under severe loading by material-aggressive solutions. The total number of six components is also an aggravating factor. In the case of an incorrect application, i.e. when used at low temperatures on concretes partially saturated with water, sticky silicone resin films can form on the material surface at elevated active substance contents. Then dust or soot particles are deposited on these sticky films, which visually impairs the surfaces. These impurities can only be removed mechanically at some expense. In applications on less exposed materials, for example, on abutments of bridges, lower penetration depths (≧3 mm) and lower active substance contents in the corresponding depth (>2 mg/n of material to be treated in the case of polysiloxanes based on isooctyltriethoxysilane) would be sufficient/necessary for a hydrophobizing.

It was therefore the object of the present invention to provide a means for hydrophobizing mineral materials which can be formulated with lower concentrations of alkyltrialkoxysilane (A) and with fewer components and which also overcomes the aforesaid disadvantages.

This object is solved by a alkyltrialkoxysilane dispersion gel according to claim 1, and by a method of manufacture according to claim 16 and a use according to claim 17. Further preferred embodiments are obtained from the dependent claims.

In other words the object is solved by a hydrophobizing dispersion gel which relative to a total quantity of 100 wt. % has the components:
(A) 0.1-less than 50 wt. % akyltrialkoxysilane,
(B) 0.1-1.0 wt. % branched polyacrylic acid,
(C) 0.5-2.0 wt. % trialkyl-amine-N-oxide,
(D) 3.0-10 wt. % non-ionic tenside and
(E) 10-80 wt. % water, where components (C) and (D) are defined more precisely hereinafter.

The expression “less than 50 wt. %” alkyltrialkoxysilane means that 50.0 wt. % is not covered but all values up to 49.99999 wt. %.

With this hydrophobizing dispersion gel according to the invention, which has less than 50 wt. % alkyltrialkoxysilane, penetration depths of ≧3 mm are achieved with an active substance content at this depth (3-4 mm) of >2 mg/g of treated material. In comparison the highly viscous emulsion (“Wacker cream”) requires active substance contents of the order of magnitude of 80-90 wt. %.

The dispersion gels according to the invention, in particular compared to the systems having 50 or more wt. % of component (A) have a significantly improved incorporability of the components in the hydrophilic gel [explanation for the term “hydrophilic gel” hereinafter, for example, in the section “constitution/structure of the hydrophobizing dispersion gel” hydrophilic gel\hat{=}amine oxide (C), branched polyacrylic acid (B), part of water (E)] and are significantly more stable in direct comparison. It should further be emphasized that only five components must be used, i.e. that compared to DE 10 2011 003 975.9, the tensidic amine oxide is omitted.

A “dispersion gel” designates a finely dispersed (colloidal) system comprising at least one solid phase and one liquid phase. The solid phase is present in the form of a sponge-like, three-dimensional hydrophilic network in which the liquid phase (an oil-in-water emulsion) is absorbed. The gels are with regard to their mechanical properties in a solid-like state. Such a state is characterized by components distributed uniformly in the entire system. These dispersion gels according to the invention are reactive and accordingly have a hydrophobizing effect on the surfaces to which they are applied. The dispersion gels according to the invention have viscosities of 3,500 to 6,000 mPa s, preferably of 4,000 to 5,000 mPa s.

The content of component (A) is preferably 5.0 to less than 50 wt. %, where the total quantity of all the components is 100 wt. %.

This preferred range can be divided into two further preferred ranges depending on the planned application:
1) for application in brick, natural stone, porous concrete, concrete building blocks, the content of component (A) is preferably 5.0-30 wt. %, where the total quantity of all the components is 100 wt. %.
2) for application in concrete the content of component (A) is preferably 30 to less than 50 wt. %, where the total quantity of all the components is 100 wt. %.
In brick, natural stone and porous concrete it is primarily a question of preventing the ingress of rain water. In the case of rain this acts on the facade surface and is transported from there by capillary suction into the material. Associated with this is a considerable reduction in the heat insulating properties of the material, as practical experience shows, whereby rooms with damp walls do not become warm. In addition to the restriction of use, this also means a significantly increased energy consumption. In contrast to this, these materials are also characterized by a different pore structure compared with high-performance concretes. The overall porosity is higher and the pore size distribution is shifted towards coarser pores. Overall here the inner surface of the surface area of the material is comparatively lower, the required amount of active substance for hydrophobizing is therefore smaller. Thus, lower active substance concentrations in the products are sufficient.
In concrete building blocks the porosity is also significantly higher compared with structural concrete. By using the hydrophobizing agent, the penetration of chlorides should not also be prevented since these building materials are not reinforced. Chloride-induced corrosion of the reinforcement therefore does not pose a risk. Moreover the frost resistance should be increased in this way so that in concrete building blocks lower active substance concentrations in the products are sufficient.
In concrete (structural concrete) the penetration resistance to chloride-induced corrosion should be significantly improved by hydrophobizing in reinforced structurally relevant components. With effective hydrophobizing, the absorption of water is virtually prevented. On the other hand however a higher active substance content is required since as a result of the pore structure, the fraction of capillary pore surface to be hydrophobized is higher.

Preferably the hydrophobizing dispersion gel additionally contains 0.1-50 wt. % of alcohol, where the total quantity of all the components gives 100% and where the alcohol is present alone or in a mixture and is selected from the group of bivalent C2-C6 alcohols, preferably ethylene glycol, 1,2-propanediol, 1,3-propanediol, 1,2-butanediol or 2,3-butanediol, trivalent C3-C6 alcohols, preferably glycerin, and ether alcohols, preferably diethylene glycol, triethylene glycol, ethylene glycol monoethylether, diethylene glycol monoethylether, dipropylene glycol monomethylether, polyethylene glycols or polypropylene glycols.

The alkyltrialkoxysilane (A) is present alone or in a mixture of several alkyltrialkoxysilanes or as a partial condensate of one or more alkyltrialkoxysilanes.

The alkyltrialkoxysilane (A) has as the alkyl group unbranched or branched C1-C16 alkyl groups, which are preferably selected from methyl, ethyl, n-propyl, iso-propyl, n-butyl, iso-butyl, n-pentyl , iso-pentyl, n-hexyl, iso-hexyl, n-octyl, iso-octyl, n-decyl, iso-decyl, n-dodecyl, iso-dodecyl, n-tetradecyl, iso-tetradecyl, hexadecyl and iso-hexadecyl groups, where an iso-octyl group (2,4,4-trimethylpentyl residue) is particularly preferred. The same or different unbranched or branched C1-C6 alkoxy groups are contained as alkoxy groups which are preferably selected from methoxy, ethoxy, n-propoxy, iso-propoxy, n-butoxy, iso-butoxy, n-pentoxy, or n-hexoxy groups, where ethoxy groups are particularly preferred. In a particularly preferred embodiment the alkyltrialkoxysilane (A) is (2,4,4-trimethyl-pentyl)-triethoxysilane.

The branched polyacrylic acid (B) is a cross-linked copolymer of acrylic acid where this preferably has polyacrylic acid cross-linked with pentaerythritol triallylether. In other words the branched polyacrylic acid (B) is an interpolymer of acrylic acid which constitutes polyacrylic acid cross-linked with pentaerythritol triallylether. Particularly suited as component (B) is a polyacrylic acid which is distributed under the trade name Carbopol® by Lubrizol. It is particularly preferable to use Carbopol ETD 2020.

The trialkyl-amine-N-oxide (C) is an amine oxide having the general formula I,

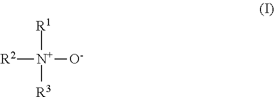

where R¹, R² and R³ are each independently of one another the same or different and selected from C₁-C₆ alkyl groups which are unsubstituted or substituted with one or more hydroxyl groups, where optionally two of the residues R¹, R² and R³ together form a saturated ring which optionally contains another oxygen atoms and where the residues R¹, R² and R³ independently of one another are optionally substituted by an —N+(R¹, R²)—O⁻ group, wherein R¹ and R² have the meaning already mentioned; wherein the trialkyl-amine-N-oxide (C) is preferably selected from the group of tris(2-hydroxyethyl)amine oxide, tris(2-hydroxypropyl)amine oxide, methyl-bis(2-hydrox-yethyl)amine oxide, ethyl-bis-(2-hydroxyethyl)amine oxide, dimethyl-2-hydroxyethyl-amine oxide, diethyl-2-hydroxyethylamine oxide, dimethyl-2-hydroxypropylamine oxide, N-methyl-morpholine oxide, N-methyl-piperidine oxide, N,N,N′, N′-tetrakis(2-hydroxypropyl)-ethylenediamine dioxide, N,N,N′,N′-tetrakis(2-hydroxyethyl)-ethylenediamine dioxide, N-(2-hydroxyethyl)-morpholine oxide and N-(2,3-dihydroxypropyl)-morpholine oxide.

For the non-ionic tenside (D) there are four alternatives a) to d) which are explained hereinafter with reference to Figures (lla) to (lld).

a) The non-ionic tenside (D) in one embodiment is a compound of the general formula (lla),

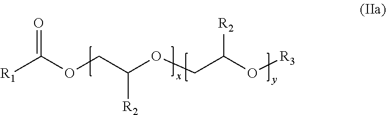

wherein
R₁ denotes alkyl or alkenyl residues with 6 to 22, as well as mixtures of these residues,
R₂ denotes hydrogen or a methyl groups,
R₃ denotes hydrogen or alkyl groups with 1 to 6 carbon atoms and

x and y are numbers from 1 to 25, [degrees of alkoxylation]. Degree of alkoxylation means in other words the number of respective alkoxy groups.

Used as preferred representatives of the residue R₁ in formula (lla) are, for example, capronyl, caprinyl, decyl, undecenyl, lauryl, myristyl, palmityl, stearyl, oleyl, ricinolyl, elaidyl, linolyl, linolenyl and erucyl residues as well as mixture of these residues.

If the residue R₃ in formula (lla) is hydrogen, these compounds (lla) are polyalkyleneglycol-α-monofatty acid esters or if R₃ is an alkyl group, they are on the other hand polyalkyleneglycol-α-fatty acid ester-ω-alkylether.

b) Alternatively the non-ionic tenside (D) is an N-n-alkyl-N,N-polyoxyalkylene-amine-monofatty acid ester of the general formula (llb),

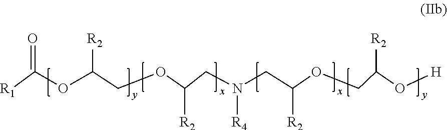

wherein R₄ denotes alkyl groups with 1 to 6 carbon atoms optionally bound via hetero atoms, preferably oxygen, such as —[CH₂—CH(R₂)—O]ₓ—[CH₂—CH(R₂)—O]_{y}—H and the residues R₁ and R₂ as well as the degrees of alkoxylation x and y have the meanings already mentioned above for formula (lla).

Used as preferred representatives of the residue R₁ in formula (llb) similarly to (lla) are, for example, capronyl, caprinyl, decyl, undecenyl, lauryl, myristyl, palmityl, stearyl, oleyl, ricinolyl, elaidyl, linolyl, linolenyl and erucyl residues as well as mixture of these residues.

Used as particularly preferred representatives of formula (llb) are:
(N-methyl-N,N-decaoxyethylene-amine-monooctadecanoic acid ester),
(N-ethyl-N,N-decaoxyethylene-amine-monooctadecanoic acid ester),
(N-propyl-N,N-decaoxyethylene-amine-monooctadecanoic acid ester) and
(N-hexyl-N,N-decaoxyethylene-amine-monooctadecanoic acid ester).
   c) Alternatively the non-ionic tenside (D) is an N-n-alkyl-N,N-polyoxyalkylene-amine oxide-monofatty acid ester of the general formula (llc),

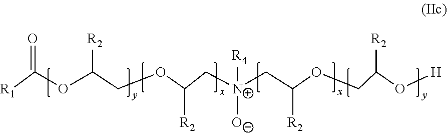

wherein R₄ denotes alkyl groups with 1 to 6 carbon atoms optionally bound via hetero atoms, preferably oxygen such as —[CH₂—CH(R₂)—O]ₓ—[CH₂—CH(R₂)—O]_{y}—H and the residues R₁ and R₂ as well as the degrees of alkoxylation x and y have the meanings already mentioned above for formula (lla).

Used as preferred representatives of the residue R₁ in formula (llc) similarly to (lla) are, for example, capronyl, caprinyl, decyl, undecenyl, lauryl, myristyl, palmityl, stearyl, oleyl, ricinolyl, elaidyl, linolyl, linolenyl and erucyl residues as well as mixture of these residues.

Used as particularly preferred representatives of formula (llc) are:
(N-methyl-N,N-decaoxyethylene-amine-monooctadecanoic acid ester),
(N-ethyl-N,N-decaoxyethylene-amine-monooctadecanoic acid ester),
(N-propyl-N,N-decaoxyethylene-amine-monooctadecanoic acid ester) and
(N-hexyl-N,N-decaoxyethylene-amine-monooctadecanoic acid ester).

Alternatively the non-ionic tenside (D) is a fatty acid-bis-(polyoxyalkylene)-amide having the general formula (lld),

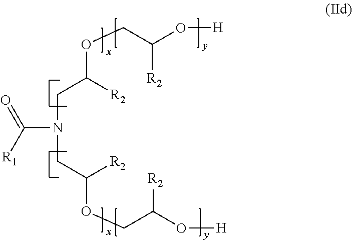

wherein the residues R₁, R₂ and the degrees of alkoxylation x and y have the same meanings already mentioned above for formula (lla).

Used as preferred representatives of the residue R₁ in formula (lld) similarly to (lla) are, for example, capronyl, caprinyl, decyl, undecenyl, lauryl, myristyl, palmityl, stearyl, oleyl, ricinolyl, elaidyl, linolyl, linolenyl and erucyl residues as well as mixture of these residues

When selecting the non-ionic tenside (D), it should be noted that the HLB value (hydrophile−lipophile−balance=hydrophilic−hydrophobic equilibrium) is preferably between 10 and 12, preferably around 11, i.e. this non-ionic tenside is water-soluble, but can also be soluble in organic liquids according to its structure in different concentrations. The utility value properties of the respectively selected tenside must be capable of forming an oil-in-water emulsion (alkyltrialkoxysilane-in-water emulsion) with the alkyltrialkoxysilane (A) used for the hydrophobizing.

The said components (B) to (E) are each contained independently of one another as an individual substance or as a mixture of various individual substances.

### Constitution/Structure of the Hydrophobizing Dispersion Gel

The amine oxide (C) together with the branched polyacrylic acid (B) and a portion of the water (E) form the basic components of the dispersion gel. They form a first hydrophilic gel which forms the basic structure. The polyanionic polyacrylic acid (B) and the cationic equilibrium fraction of the amine oxide interact by protonation by means of polyacrylic acid. The tenside (D) and the water (E) as well as optionally additional alcohol together with the silane (A) are capable of stabilizing the entire system as a result of their polar character and their capacity to form hydrogen bridging bonds.

For example, by means of the quantity of water (E), by selecting the non-ionic tenside (D), the concentration ratios, with the alcohols, the respectively desired viscosity of the preparation can be adjusted and maintained permanently if drying losses are avoided. As already mentioned above, the dispersion gels according to the invention are adjusted to viscosities of 3,500 to 6,000 mPa s, preferably of 4,000 to 5,000 mPa s.

In addition to the adjustment of the viscosity, the utility value properties can also be varied in this way, i.e. on the one hand the adhesion of the dispersion gel to the mineral surface can be varied positively or negatively, on the other hand the rates of penetration of the dispersion gel to the mineral surface can thus be varied (mineral surface=surface of a mineral material).

The mineral surface can be additionally equipped by further additives such as cationic or zwitter ion tensides or catalysts and also fining agents such as silicone oils. Such additives are tolerated by the constructed hydrophobizing dispersion gel; the alkyltrialkoxysilane-in-water emulsion has become thermodynamically stably incorporated in the hydrophilic gel constructed in the first stage by hydrophilic interaction forces.

If water losses have occurred in the system of the hydrophobizing dispersion gel, these can be corrected by addition of water alone or by addition of aqueous alcohol mixtures and the original state restored again (reversible process).

Crucial for the storage stability of the hydrophobizing dispersion gel are the selection of the individual components and their percentage fraction in the complete system during preparation and the resulting pH value, which generally lies around the neutral point

(pH=6.5 to 7.5). This avoids premature damage or decomposition of the organosilicon compounds during storage at the usual ambient temperature (5° to 30° C.).

### Preparation of the Hydrophobizing Dispersion Gel

The hydrophobizing dispersion gel should expediently be produced according to a defined process—but this is not compulsory.

A method for producing a hydrophobizing dispersion gel is preferably used which is characterized in that initially the components (B) and (C) and up to 20% of component (E) as well as optionally further additives, preferably alcohols, at temperatures between 0° C. and 50° C., preferably between 15° C. and 30° C. are stirred together to form an intermediate hydrophilic product—the hydrophilic gel—and the component (A) and, in steps, the component (D) and also in steps, the remaining fraction of component (E) are then added to the intermediate product, thus forming a multiple dispersion.

The preparation of the hydrophilic intermediate product produces a pre-swelling of the highly branched polyacrylic acid (B) so that this can evolve better in the subsequent course. Component (A) [alkyltrialkoxysilane] as well as component (D) [non-ionic tenside] and the remaining portion of component (E) [water] are then added to this intermediate product whilst stiring, thus forming the hydrophobizing dispersion gel. Preferably component (A) is initially added to the intermediate product/the pre-swollen gel, where the pre-swollen gel is distributed in the volume of component (A) by stiring. The remaining portion of component (E) [water] and component (D) [non-ionic tenside] is then added.

It is also possible to use component (A) right at the beginning. As already mentioned, a defined method is not absolutely essential. If, for example, a preparation without component (A) is attempted, this is successful but the subsequent incorporation of the active substance, i.e. component (A) is more tedious. The addition is associated with an increased expenditure of time and energy.

During the preparation process on the one hand a hydrophilic gel is constructed and on the other hand an oil-in-water emulsion, where (A) represents the oil. These two systems in their entirety undergo different interactions where ultimately a multiple disperse system is formed, the hydrophobizing dispersion gel. The dispersion gel is ready to use as soon as a uniform system has formed in which two phases can no longer be distinguished visually with the eye, i.e. separation between the hydrophilic gel and the hydrophobizing dispersion liquid is no longer visible.

The dispersion gels which can be obtained in this way as mentioned above have viscosities of 3,500 to 6,000 mPa s, preferably of 4,000 to 5.000 mPa s.

### Use

The hydrophobizing dispersion gel is used for hydrophobizing mineral materials, preferably concrete, lightweight concrete, brick, natural stone, porous concrete, concrete building block or reinforced concrete structures by application to the surfaces thereof.

As mentioned above, there are preferred options here with regard to the quantity of alkyltrialkoxysilane (A) used:
1) for application with brick, natural stone, porous concrete, concrete building block, the content of component (A) is preferably 5.0-30 wt. %, where the total quantity of all the components is 100 wt. %.
2) for application with concrete component (A) preferably has a content of 30 or less than 50 wt. % where the total quantity of all the components is 100 wt. %.

In general there is no restriction with regard to the materials to be treated, i.e. all materials from concrete to natural stone can be treated. The mineral materials also comprise reinforced concrete structures which are stabilized inside by reinforcing rods, for example, reinforced concrete structures such as bridge pillars, underground garages and buildings.

Preferably the mineral materials have an alkaline pH of ≧9. In the case of materials which are not alkaline of their own accord such as brick or natural stone, the addition of a catalyst is optionally required if there is a lack of alkalinity (dialkyl tin compound, in particular dibutyl tin dilaurate or dioctyl tin dilaurate.). These catalysts are preferably used with contents in the range of 0.007-1 wt. %. (Total content of all the components 100 wt. %). The content depends on the type of silane and the application.

The application of the dispersion gel or the polysiloxane formed therefrom drastically reduces the absorption of aqueous solutions, optionally with dissolved material-damaging chemical compounds. In this way corrosion processes can be prevented or their progress can be temporally delayed.

The hydrophobizing dispersion gel is an easy-to-handle product which can be applied by the usual method of surface coating, for example, spreading, rolling, squeegeeing or spraying on horizontal or vertical surface structures of concrete structures with a stable substructure and is ultimately completely adsorbed by this. Compared with products according to the prior art, discolorations following direct adsorption of the preparation on in particular visible concrete surfaces are not observed or only observed to a degree in which the appearance of the concrete is not permanently impaired. For application about 200 to 600 g/m² is used, where the application thickness is about 0.5 to 5 mm, preferably about 1 mm to achieve a penetration depth of ≧3 mm.

The dispersion gel penetrates immediately after application to the concrete surface and without resistance into the surface, where the penetration time can be influenced by the composition of the gel, and for practical concretes (W/Z 0.40-0.60) reaches effective penetration depths of ≧3 mm (≧2 mg polysiloxane per gram of concrete) in the concrete edge zone. This applies to concretes which were stored at 20° C. and 65% relative humidity until the equilibrium state. Furthermore, a blockade of the active substance front penetrating into the surface cannot be observed since no formation of a barrier layer occurs as a result of the formulation components, which would prevent the progress of the active substance/adjuvant front into deeper capillary space regions. In contrast to many other systems, a higher water content is harmless. As a result of the preparation of the hydrophobic dispersion gel, which has been explained previously in detail, a hydrophilic gel but also an oil-in-water emulsion is provided. These two systems exhibit different interactions in their entirety. As a result of the competing interaction forces water-dispersion phase (component A) and water-polymer matrix, by controlling the water or further additions, on the one hand the stability and on the other hand the viscosity can be adjusted, which also has an influence on the application properties (utility value properties). Additional water can easily be absorbed by the system components, for example, the hydrophilic gel, without resulting in collapse of the system.

After applying the pH-neutral hydrophobizing dispersion gel (pH=6.5 to 7.5) to a usually alkaline concrete body surface, a pH value equilibrium is established at the concrete/dispersion gel interface, which however as a result of the greater mass of the concrete body compared to the quantity of applied dispersion gel is shifted in the direction of alkaline environment. As a result, the dispersion gel is decomposed into its components, i.e. the polyacrylic acid is immobilized by the alkaline environment as polyacrylate in the front capillary region of the concrete surface and becomes bound to the cationic centres of the cement stone whilst the protonated equilibrium fractions of the amine oxide are completely released from their binding state as non-ionic amine oxides due to the higher basicity of the surroundings. Outside this boundary layer the pH value, i.e. the state of the dispersion gel, is initially maintained. The process described only progresses in the subsequent temporal course of the adsorption. As a result of the change in the pH value conditions, the viscosity of the dispersion gel increasingly diminishes until it liquefies.

The liquefied form can migrate into the deeper capillary regions with the result that the penetration depth of the active substances improves. This is also a consequence of the variation of the chemical equilibria and the interfacial tension in the capillaries of the pore space. The intact gel layer still present on the surface at this time point, by quasi “capping” the outer concrete surface, prevents the liquid fractions of the preparation located in the near-surface capillary space of the concrete edge zone from being released outwards to the environment by back-diffusion to the surface and evaporation. As a result, losses of valuable active substances are avoided and in addition further advantages are achieved such as, for example, the improvement in the utility value properties. With a given active substance fraction in the preparation, a higher efficiency can thus be achieved. It is directedly possible to adapt the active substance content to the substrate-dependent requirements of the hydrophobizing with the result that the consumption of resources is saved and the ecological compatibility is improved. As soon as the active substance has reached the equilibrium state with regard to its maximum penetration depth, the process of hydrophobizing by conversion of the organosilicon compound into a spatially fixedly anchored oligomer condensate begins in the basic environment of the pore space of the concrete edge zone. After this the process of hydrophobizing the object being treated is generally concluded. The required contact time for the object being treated is at least one hour, preferably 7-72 hours. It is dependent on the application conditions, i.e. the substrate properties (e.g. moisture content, porosity) or surface conditions. In the first reaction step the silanes (A) in the alkaline medium are hydrolyzed via organosilanols up to the organosilantriol by moisture which is either contained in the dispersion gel itself or in the form of substrate hydroxyl groups/substrate hydrates in the cement stone. The chemical reactivity, i.e. the rate of hydrolysis of the respective silanes (A) depends to a particular extent on the structure of the organic alkyl residue, the alkoxy groups or the substrate as well as on the pH value in the capillary space, the temperature and the other components, for example, solvents, tensides. Finally the organosilantriol further polycondenses via partial condensates up to the oligomer which then for its part forms covalent bonds between organic and inorganic material with the still remaining hydroxyl groups of the oligomers, one per monomer unit, and with the hydroxyl groups of the substrate initially forming a hydrogen bridge bond and then further up to polycondensation, fills the capillary space of the concrete edge zone and makes it hydrophobic. Depending on the reactivity of the silanes and the alkalinity of the substrate, the entire hydrophobizing procedure generally takes a period of 2 to 4 weeks, with a water-repellent effect being achieved substantially faster (after about 8-12 h). A hydrophobization is achieved, i.e. an effective penetration depth of at least 3 mm.

### DESCRIPTION OF THE FIGURES

FIG. 1: shows the capillary transport of the silicon organic compounds in the concrete edge zone.

FIG. 2: FIG. 2 shows schematically the hydrolysis of silicon-organic compounds in the pore solution of cement-bound materials (concrete).

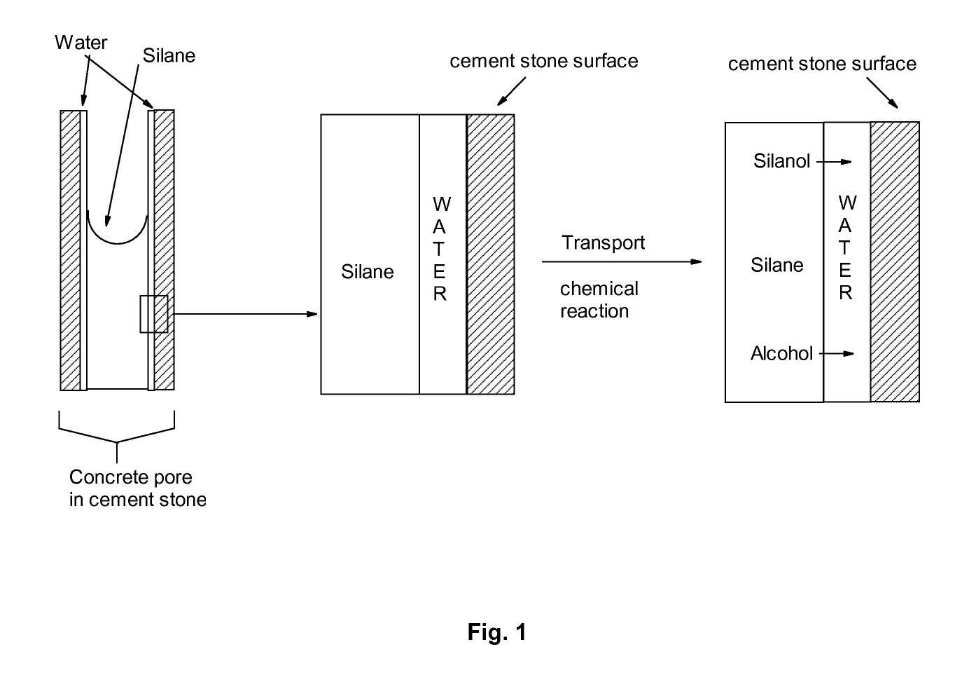

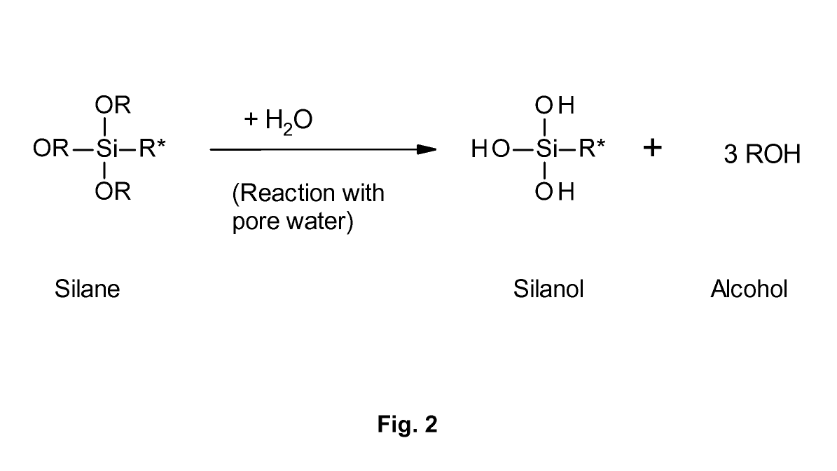

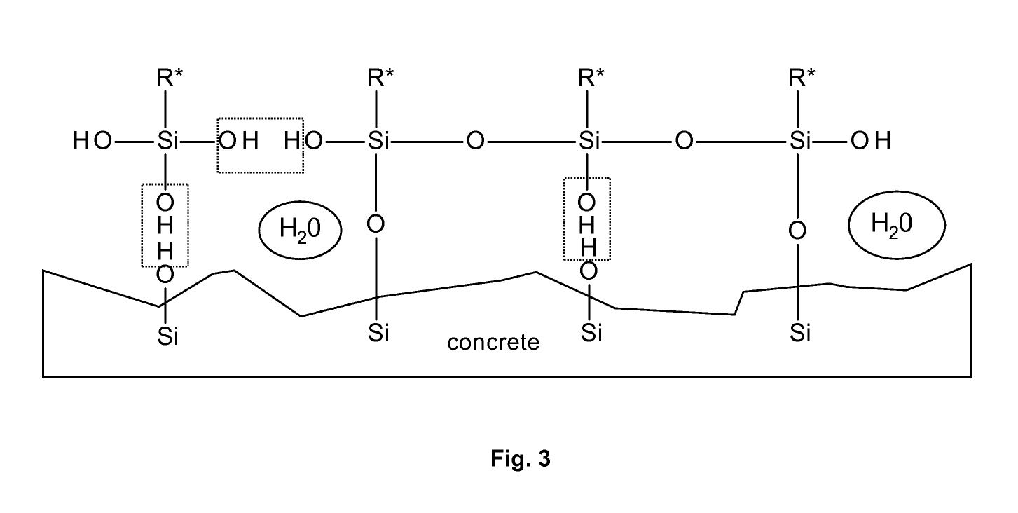

Abb. 3: FIG. 3 reproduces schematically the polycondensation and binding of the silanols to the surface of the cement-bound material (concrete).

The invention is explained hereinafter with reference to examples without the invention being restricted to these.

### EXAMPLES

All quantitative details, fractions and percentage fractions, unless specified otherwise, are related to the weight and the total quantity or to the total weight of the preparations. In each example the sum of all the individual components is 100 wt. %.

### Preparation of the Hydrophobizing Dispersion Gel

The components branched polyacrylic acid (B) (preferably Carbopol), amine oxide (C), parts of the water (E) (maximum half) and optionally alcohol are mixed and left to stand for some time until a hydrophilic gel (intermediate product) has formed. Then the silane (A) is added. The non-ionic tenside (D) and the residual water (E) is added so that a first oil/water dispersion can form and subsequently the hydrophilic gel grows and then forms with the dispersion the stable hydrophobizing dispersion gel. The mixture is gently stired so that the disperse system is formed more rapidly through this energy input. When a white opaque creamy mixture has formed, the preparation process is completed.

### Example 1

| | | |
|---|---|---|
| 30 | wt. % | Isooctyltriethoxysilane |
| 0.3 | wt. % | Carbopol ETD 2020 |
| 1 | wt. % | 70% aqueous N-methylmorpholine oxide |
| 63.7 | wt. % | Water |
| 5.0 | wt. % | non-ionic tenside (IIa) Conol 5203 - Zschimmer & |
| | | Schwarz - heptaethyleneglycol-α-monooleic acid |
| | | ester-ω-methylether |

### Example 2

| | | |
|---|---|---|
| 30 | wt. % | Isooctyltriethoxysilane |
| 0.3 | wt. % | Carbopol ETD 2020 |
| 1 | wt. % | 70% aqueous N-methylmorpholine oxide |
| 63.1 | wt. % | Water |
| 5.6 | wt. % | Non-ionic tenside (IIa) (Berol 828 - castor oil + |
| | | 15 ethylene oxide units) |

### Example 3

| | | |
|---|---|---|
| 10 | wt. % | Organofunctional polysiloxane - TEGOSIVIN HL 101 |
| 0.3 | wt. % | Carbopol ETD 2020 |
| 1 | wt. % | 70% aqueous N-methylmorpholine oxide |
| 82.2 | wt. % | Water |
| 6.5 | wt. % | Non-ionic tenside (IId) - octadecanoic acid-bis(oxyethylene- |
| | | pentaoxypropylene)-amide |

### Example 4

| | | |
|---|---|---|
| 10 | wt. % | Organofunctional polysiloxane - TEGOSIVIN HL 101 |
| 0.25 | wt. % | Carbopol ETD 2020 |
| 1 | wt. % | 70% aqueous N-methylmorpholine oxide |
| 25 | wt. % | Propyleneglycol-1,2 |
| 58.75 | wt. % | Water |
| 5 | wt. % | Non-ionic tenside - (IIa) Conol 5203 - Zschimmer & |
| | | Schwarz - Heptaethyleneglycol-α-monooleic acid |
| | | ester-ω-methylether |

### Example 5

| | | |
|---|---|---|
| 30 | wt. % | Isooctyltriethoxysilane |
| 0.3 | wt. % | Carbopol ETD 2020 |
| 1 | wt. % | 70% aqueous N-methylmorpholine oxide |
| 25 | wt. % | Glycerin |
| 38.2 | wt. % | Water |
| 5.5 | wt. % | Non-ionic tenside (IIa) (Berol 828 - castor oil + |
| | | 15 ethylene oxide units) |

### Example 6

| | | |
|---|---|---|
| 30 | wt. % | Isooctyltriethoxysilane |
| 0.3 | wt. % | Carbopol ETD 2020 |
| 1 | wt. % | 70% aqueous N-methylmorpholine oxide |
| 20 | wt. % | Propyleneglycol-1,2 |
| 42.7 | wt. % | Water |
| 6 | wt. % | Non-ionic tenside (IIa) Conol 5203 - Zschimmer & |
| | | Schwarz - Heptaethyleneglycol-α-monooleic acid |
| | | ester-ω-methylether |

### Example 7

| | | |
|---|---|---|
| 10 | wt. % | Organofunctional polysiloxane - TEGOSIVIN HL 101 |
| 0.3 | wt. % | Carbopol ETD 2020 |
| 1 | wt. % | 70% aqueous N-methylmorpholine oxide |
| 20 | wt. % | Glycerin |
| 60.6 | wt. % | Water |
| 8.1 | wt. % | Non-ionic tenside (IId) - Octadecanoic acid- |
| | | bis(oxyethylene-pentaoxypropylene)-amide |

### Example 8

| | | |
|---|---|---|
| 30 | wt. % | Isooctyltriethoxysilane |
| 0.25 | wt. % | Carbopol ETD 2020 |
| 1 | wt. % | 70% aqueous N-methylmorpholine oxide |
| 40 | wt. % | Glycerin |
| 19.75 | wt. % | Water |
| 6 | wt. % | Non-ionic tenside (IId) - Octadecanoic acid- |
| | | bis(oxyethylene pentaoxypropylene)-amide |
| 3 | wt. % | Non-ionic tenside (IIa) Conol 5203 - Zschimmer & |
| | | Schwarz - Heptaethyleneglycol-α-monooleic acid |
| | | ester-ω-methylether |

### Example 9

| | | |
|---|---|---|
| 30 | wt. % | Isooctyltriethoxysilane |
| 0.3 | wt. % | Carbopol ETD 2020 |
| 1 | wt. % | 70% aqueous N-methylmorpholine oxide |
| 40 | wt. % | Propyleneglycol-1,2 |
| 19.7 | wt. % | Water |
| 5 | wt. % | Non-ionic tenside (IId) - Octadecanoic acid- |
| | | bis(oxyethylene-pentaoxypropylene)-amide |
| 4 | wt. % | Non-ionic tenside (IIa) Conol 5203 - Zschimmer & |
| | | Schwarz - Heptaethyleneglycol-α-monooleic acid |
| | | ester-ω-methylether |

### Example 10

| | | |
|---|---|---|
| 20 | wt. % | Isooctyltriethoxysilane |
| 0.25 | wt. % | Carbopol ETD 2020 |
| 1 | wt. % | 70% aqueous N-methylmorpholine oxide |
| 73.75 | wt. % | Water |
| 5 | wt. % | Non-ionic tenside (IIa) Conol 5203 - Zschimmer & |
| | | Schwarz - Heptaethyleneglycol-α-monooleic acid |
| | | ester-ω-methylether |

### Example 11

| | | |
|---|---|---|
| 5 | wt. % | Isooctyltriethoxysilane |
| 0.25 | wt. % | Carbopol ETD 2020 |
| 1 | wt. % | 70% aqueous N-methylmorpholine oxide |
| 88.75 | wt. % | Water |
| 5 | wt. % | Non-ionic tenside (IId) - Octadecanoic acid-bis(oxyethylene |
| | | pentaoxypropylene) amide |

### Example 12

| | | |
|---|---|---|
| 20 | wt. % | Isooctyltriethoxysilane |
| 0.25 | wt. % | Carbopol ETD 2020 |
| 1 | wt. % | 70% aqueous N-methylmorpholine oxide |
| 73.75 | wt. % | Water |
| 5 | wt. % | Non-ionic tenside (IIa) (Chremophor CO 40 - castor oil + |
| | | 40 ethylene oxide units) |

### Example 13

| | | |
|---|---|---|
| 15 | wt. % | Isooctyltriethoxysilane |
| 0.4 | wt. % | Carbopol ETD 2020 |
| 1 | wt. % | 70% aqueous N-methylmorpholine oxide |
| 25 | wt. % | Propyleneglycol-1,2 |
| 53.6 | wt. % | Water |
| 5 | wt. % | Non-ionic tenside (IId) - Octadecanoic acid- |
| | | bis(oxyethylene-pentaoxypropylene) amide |

### Example 14

| | | |
|---|---|---|
| 10 | wt. % | Organofunctional polysiloxane - TEGOSIVIN HL 101 |
| 0.25 | wt. % | Carbopol ETD 2020 |
| 1 | wt. % | 70% aqueous N-methylmorpholine oxide |
| 25 | wt. % | Propylene glycol-1,2 |
| 58.75 | wt. % | Water |
| 5 | wt. % | Non-ionic tenside (IIa) (Chremophor CO 40 - castor oil + |
| | | 40 ethylene oxide units) |

### Example 15

| | | |
|---|---|---|
| 20 | wt. % | Isooctyltriethoxysilane |
| 0.5 | wt. % | Carbopol ETD 2020 |
| 1 | wt. % | 70% aqueous N-methylmorpholine oxide |
| 25 | wt. % | Glycerin |
| 58.75 | wt. % | Water |
| 4 | wt. % | Octadecyl-di(polyoxyalkylene)ammonio-propanesulfonate |
| | | (Polyoxyalkylene = 9 ethylene oxide units) |
| 5 | wt. % | Non-ionic tenside (IIa) (Chremophor CO 40 - castor oil + |
| | | 40 ethylene oxide units) |

### Example 16

| | | |
|---|---|---|
| 20 | wt. % | Isooctyltriethoxysilane |
| 0.5 | wt. % | Carbopol ETD 2020 |
| 1 | wt. % | 70% aqueous N-methylmorpholine oxide |
| 25 | wt. % | Glycerin |
| 44.5 | wt. % | Water |
| 5 | wt. % | Non-ionic tenside (IId) - Octadecanoic acid- |
| | | bis(oxyethylene pentaoxypropylene) amide |
| 4 | wt. % | Non-ionic tenside (IIa) (Chremophor CO 40 - castor oil + |
| | | 40 ethylene oxide units) |

### Example 17

| | | |
|---|---|---|
| 10 | wt. % | Organofunctional polysiloxane - TEGOSIVIN HL 101 |
| 0.25 | wt. % | Carbopol ETD 2020 |
| 1 | wt. % | 50% aqueous triisopropanolamine oxide |
| 83.75 | wt. | Water |
| 5 | wt. % | Non-ionic tenside (IIa) (Chremophor CO 40 - castor oil + |
| | | 40 ethylene oxide units) |

### Example 18

| | | |
|---|---|---|
| 15 | wt. % | Organofunctional polysiloxane - TEGOSIVIN HL 101 |
| 0.25 | wt. % | Carbopol ETD 2020 |
| 1 | wt. % | 50% aqueous triisopropanolamine oxide |
| 25 | wt. % | Propylene glycol-1,2 |
| 53.75 | wt. % | Water |
| 5 | wt. % | Non-ionic tenside (IIa) Conol 5203 - Zschimmer & |
| | | Schwarz - Heptaethylene glycol-α-monooleic acid |
| | | ester-ω-methylether |

### Example 19

| | | |
|---|---|---|
| 30 | wt. % | Isooctyltriethoxysilane |
| 0.25 | wt. % | Carbopol ETD 2020 |
| 1 | wt. % | 50% aqueous triisopropanolamine oxide |
| 40 | wt. % | Propylene glycol-1,2 |
| 23.75 | wt. % | Water |
| 5 | wt. % | Non-ionic tenside (IIa) Conol 5203 - Zschimmer & |
| | | Schwarz - Heptaethylene glycol-α-monooleic acid |
| | | ester-ω-methylether |

### Example 20

| | | |
|---|---|---|
| 10 | wt. % | Isooctyltriethoxysilane |
| 0.25 | wt. % | Carbopol ETD 2020 |
| 1 | wt. % | 50% aqueous triisopropanolamine oxide |
| 25 | wt. % | Glycerin |
| 57.75 | wt. % | Water |
| 6 | wt. % | Non-ionic tenside (IId) - Octadecanoic acid- |
| | | bis(oxyethylene pentaoxypropylene) amide |

### Example 21

| | | |
|---|---|---|
| 30 | wt. % | Isooctyltriethoxysilane |
| 0.4 | wt. % | Carbopol ETD 2020 |
| 1 | wt. % | 50% aqueous triisopropanolamine oxide |
| 40 | wt. % | Glycerin |
| 23.6 | wt. % | Water |
| 5 | wt. % | Non-ionic tenside (IIa) Conol 5203 - Zschimmer & |
| | | Schwarz - Heptaethyleneglycol-α-monooleic acid |
| | | ester-ω-methylether |

### Example 22

| | | |
|---|---|---|
| 30 | wt. % | Isooctyltriethoxysilane |
| 0.6 | wt. % | Carbopol ETD 2020 |
| 1 | wt. % | 50% aqueous triisopropanolamine oxide |
| 50 | wt. % | Propyleneglycol-1,2 |
| 10.4 | wt. % | Water |
| 8 | wt. % | Non-ionic tenside (IIa) Conol 5203 - Zschimmer & |
| | | Schwarz - Heptaethylene glycol-α-monooleic acid |
| | | ester-ω-methylether |

### Example 23

| | | |
|---|---|---|
| 30 | wt. % | Isooctyltriethoxysilane |
| 0.3 | wt. % | Carbopol ETD 2020 |
| 1 | wt. % | 65% aqueous triethanolamine oxide |
| 63.7 | wt. % | Water |
| 5 | wt. % | Non-ionic tenside (IIa) (Chremophor CO 40 - castor oil + |
| | | 40 ethylene oxide units) |

### Example 24

| | | |
|---|---|---|
| 20 | wt. % | Isooctyltriethoxysilane |
| 0.3 | wt. % | Carbopol ETD 2020 |
| 1 | wt. % | 50% aqueous dimethylethanolamine oxide |
| 72.7 | wt. % | Water |
| 6 | wt. % | Non-ionic tenside (IIc) (N-Methyl-N,N-decaoxyethylene |
| | | amine oxide monooctadecanoic acid ester) |

### Example 25

| | | |
|---|---|---|
| 25 | wt. % | Isooctyltriethoxysilane |
| 0.3 | wt. % | Carbopol ETD 2020 |
| 1 | wt. % | 50% aqueous tributylamine oxide |
| 63.7 | wt. % | Water |
| 5 | wt. % | cationic tenside (N-methyl-N,N-bis-(hydroxypropylene- |
| | | mono-/di-propoxylene-oxyethylene)-ammonio-acetic acid- |
| | | siloxanylamide chloride) |
| 5 | wt. % | Non-ionic tenside (IIa) (Chremophor CO 40 - castor oil + |
| | | 40 ethylene oxide units) |

### Example 26

| | | |
|---|---|---|
| 20 | wt. % | Isooctyltriethoxysilane |
| 0.3 | wt. % | Carbopol ETD 2020 |
| 1 | wt. % | 65% aqueous triethanolamine oxide |
| 25 | wt. % | Propylene glycol-1,2 |
| 44.7 | wt. % | Water |
| 5 | wt. % | Non-ionic tenside (IIb) (N-methyl-N,N-decaoxyethylene |
| | | amine monooctadecanoic acid ester) |
| 4 | wt. % | Non-ionic tenside (IIa) (Chremophor CO 40 - castor oil + |
| | | 40 ethylene oxide units) |

### Example 27

| | | |
|---|---|---|
| 20 | wt. % | Isooctyltriethoxysilane |
| 0.3 | wt. % | Carbopol ETD 2020 |
| 1 | wt. % | 50% aqueous dimethylethanolamine oxide |
| 25 | wt. % | Propylene glycol-1,2 |
| 44.7 | wt. % | Water |
| 5 | wt. % | Non-ionic tenside (IIb) (N-methyl-dioxyethylene- |
| | | octaoxypropylene-amine monododecanoic acid ester) |
| 4 | wt. % | Non-ionic tenside (IIa) (Chremophor CO 40 - castor oil + |
| | | 40 ethylene oxide units) |

### Example 28

| | | |
|---|---|---|
| 30 | wt. % | Isooctyltriethoxysilane |
| 0.3 | wt. % | Carbopol ETD 2020 |
| 1 | wt. % | 50% aqueous tributylamine oxide |
| 25 | wt. % | Propylene glycol-1,2 |
| 33.7 | wt. % | Water |
| 5 | wt. % | Cationic tenside (N-methyl-N,N-bis-(hydroxypropylene- |
| | | mono-/di-propoxylene-oxyethylene)-ammonio-acetic acid- |
| | | siloxanylamide chloride) |
| 5 | wt. % | Non-ionic tenside (IIa) (Chremophor CO 40 - castor oil + |
| | | 40 ethylene oxide units) |

### Example 29

### Application of a Hydrophobizing Dispersion Gel Having a Composition According to Example 22

### Preparation of the Samples

The hydrophobizing dispersion gel according to Example 22 is applied to a concrete which has the following composition (see Table 1).

TABLE 1
Formulation of the concrete slab
Concrete formulation: W/Z factor 0.50

| | | Mass fractions | Volume fraction |
|---|---|---|---|
| Designation | Component | in kg/m³ | in dm³/m³ |
| Sand, 0-4 mm | | 833.00 | 314.34 |
| Sand, 4-8 mm | | 370.22 | 139.71 |
| Gravel, 8-16 mm | | 647.89 | 244.49 |
| Aggregate total | | 1,851.12 | 698.54 |
| Portland cement | Portland CEM I | 350.00 | 111.46 |
| CEM I 42.5 | 42.5 | | |
| Water | | 175.00 | 175.00 |
| Concrete liquefier | — | — | — |
| Air pores | | — | 15.00 |
| (assumed) | | | |
| Total | | 2,376.12 | 1,000.00 |

For practical preparation of the concrete, the fractions listed above were converted to a fresh concrete volume of 70 litre and the components thus specified were added in the order aggregate, cement and water to a pug mill mixer. This mixture was then mixed intensively for 60 seconds.

This mixture was placed in a shuttering made of Resopal boards (without shuttering oil) and compacted with a vibrating table for about 2 min. After the preparation, the shuttering thus filled, covered with a PE film, was stored for 24 hours at 20° C. and 65% rel. humidity (rel. hm.). After this time the slab was stripped and stored for 7 days in tap water (KIT network). This was followed by storage in the laboratory at 20° C. and 65% rel. humidity. The total porosity of the concrete determined by means of mercury pressure porosimetry was determined as 13 vol. %.

Approximately 250 g/m² of the hydrophobizing agent (composition according to Example 22) calculated for each concrete slab was applied to the vertically mounted concrete slab by the airless method. One slab in each case was left untreated as reference surface.

After 14 days—during this time the silane reacts to the water-repellent silicon resin lining the capillary inner surfaces—drilling cores having a diameter of 70 mm were drilled from the slabs. These drilling cores were milled in 1 mm steps using a modified milling machine tool.

In the powder collected per milling step (for method see A. Gerdes, D. Oehmichen, B. Preindl and R. Nüesch, Chemical Reactivity of Silanes in Cement-Based Materials in: J. Silfwerbrand (ed.), Hydrophobe IV—Water Repellent Treatment of Building Materials, Aedificatio Publishers, Freiburg i.Br. 47-58 (2005)) the content of isooctylpolysiloxane was determined quantitatively by means of FTIR spectroscopy. At a distance of 3 mm, an active substance content of 2.5 mg/g of concrete was determined for the hydrophobizing dispersion gel.

### Example 30

### Application of a hydrophobizing dispersion gel having a composition according to Example 28

### Preparation of the Samples

The hydrophobizing dispersion gel according to Example 28 is applied to a concrete which has the following composition.

TABLE 1
Formulation of the concrete slab
Concrete formulation: W/Z factor 0.40

| | | Mass fractions | Volume fraction |
|---|---|---|---|
| Designation | Component | in kg/m³ | in dm³/m³ |
| Sand, 0-4 mm | | 833.00 | 314.34 |
| Sand, 4-8 mm | | 370.22 | 139.71 |
| Gravel, 8-16 mm | | 647.89 | 244.49 |
| Aggregate total | | 1,851.12 | 698.54 |
| Portland cement | Portland CEM I | 350.00 | 111.46 |
| CEM I 42.5 | 42.5 | | |
| Water | | 175.00 | 175.00 |
| Concrete liquefier | — | — | — |
| Air pores | | — | 15.00 |
| (assumed) | | | |
| Total | | 2,376.12 | 1,000.00 |

For practical preparation of the concrete, the fractions listed above were converted to a fresh concrete volume of 70 litre and the components thus specified were added in the order aggregate, cement and water to a pug mill mixer. This mixture was then mixed intensively for 60 seconds.

This mixture was placed in a shuttering made of Resopal boards (without shuttering oil) and compacted with a vibrating table for about 2 min. After the preparation, the shuttering thus filled, covered with a PE film, was stored for 24 hours at 20° C. and 65% rel. humidity (rel. hm.). After this time the slab was stripped and stored for 7 days in tap water (KIT network). This was followed by storage in the laboratory at 20° C. and 80% rel. humidity. The total porosity of the concrete determined by means of mercury pressure porosimetry was determined as 6 vol. %.

Approximately 250 g/m² of the hydrophobizing agent (composition according to Example 2) calculated for each concrete slab was applied to the vertically mounted concrete slab by the airless method. One slab in each case was left untreated as reference surface.

After 14 days—during this time the silane reacts to the water-repellent silicon resin lining the capillary inner surfaces—drilling cores having a diameter of 70 mm were drilled from the slabs. These drilling cores were milled in 1 mm steps using a modified milling machine tool.

In the powder collected per milling step (for method see A. Gerdes, D. Oehmichen, B. Preindl and R. Nüesch, Chemical Reactivity of Silanes in Cement-Based Materials in: J. Silfwerbrand (ed.), Hydrophobe IV—Water Repellent Treatment of Building Materials, Aedificatio Publishers, Freiburg i.Br. 47-58 (2005)) the content of isooctylpolysiloxane was determined quantitatively by means of FTIR spectroscopy. At a distance of 3 mm, an active substance content of 2.5 mg/g of concrete was determined for the hydrophobizing dispersion gel of Example 28.

It should be stressed that Example 28 also achieves an acceptable penetration depth at high moisture contents.

1. Hydrophobizing dispersion gel comprising relative to a total quantity of 100 wt. % the components:
(A) 0.1 wt. %-less than 50 wt. % alkyltrialkoxysilane,
(B) 0.1 wt. %-1.0 wt. % branched polyacrylic acid,
(C) 0.5 wt. %-2.0 wt. % trialkyl-amine-N-oxide,
(D) 3.0 wt. %-10 wt. % non-ionic tenside and
(E) 10 wt. %-80 wt. % water, wherein
the trialkyl-amine-N-oxide (C) is an amine oxide having the general formula I, 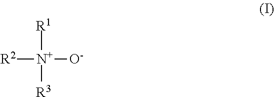
wherein R¹, R², and R³ are each independently of one another the same or different and selected from C₁-C₆ alkyl groups which are unsubstituted or substituted with one or more hydroxyl groups, where optionally two of the residues R¹, R², and R³ together form a saturated ring which optionally contains another oxygen atoms and where the residues R¹, R², and R³ independently of one another are optionally substituted by an —N⁺(R¹, R²)—O⁻group, and
the non-ionic tenside (D) is either
a) a tenside having the general formula (lla) 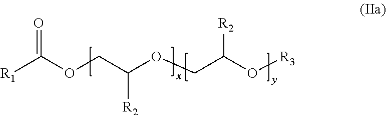
or
b) a tenside having the general formula (llb) 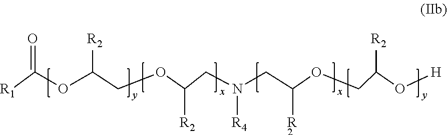
or
c) a tenside having the general formula (llc) 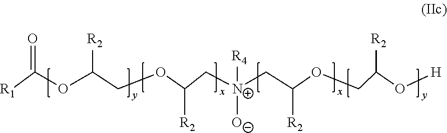
or
d) a fatty acid-bis-(polyoxyalkylene)-amide having the general formula (lld), 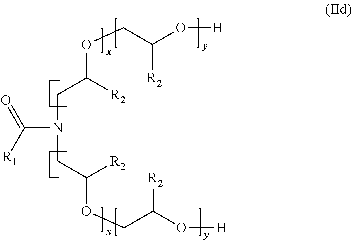
wherein the residues R₁-R₄ of the non-ionic tenside (D) each have the following meaning:
R₁ are alkyl or alkenyl residues having 6 to 22 carbon atoms as well as mixtures of these residues,
R₂ is hydrogen or a methyl group,
R₃ is hydrogen or alkyl groups having 1 to 6 carbon atoms,
R₄ are alkyl groups with 1 to 6 carbon atoms optionally bound via hetero atoms, preferably oxygen,
and
x and y are numbers from 1 to 25.

2. The hydrophobizing dispersion gel according to claim 1, wherein the content of component (A) is 5.0 wt. % to less than 50 wt. %, wherein the total quantity of all the components is 100 wt. %.

3. The hydrophobizing dispersion gel according to claim 2, wherein the content of component (A) is 5.0 wt. % -30 wt. %, wherein the total quantity of all the components is 100 wt. %.

4. The hydrophobizing dispersion gel according to claim 2, wherein the content of component (A) is 30 wt. % to less than 50 wt. %, wherein the total quantity of all the components is 100 wt. %.

5. The hydrophobizing dispersion gel according to claim 1, wherein, in addition, 0.1 wt. % -50 wt. % of alcohol is contained, wherein the total content of all the components gives 100% and wherein the alcohol is present alone or in a mixture and is selected from the group consisting of divalent C₂-C₆ alcohols, trivalent C₃-C₆ alcohols, ether alcohols, polyethylene glycols, and polypropylene glycols.

6. The hydrophobizing dispersion gel according to claim 1, wherein the alkyltrialkoxysilane (A) comprises as the alkyl group unbranched or branched C₁-C₁₆ alkyl groups and as alkoxy groups the same or different unbranched or branched C₁-C₆-alkoxy groups.

7. The hydrophobizing dispersion gel according to claim 1, wherein the alkyltrialkoxysilane (A) is 2,4,4-trimethyl-pentyl-triethoxysilane.

8. The hydrophobizing dispersion gel according to claim 1, wherein the alkyltrialkoxysilane (A) is present alone or in a mixture of several alkyltrialkoxylsilanes or as a partial condensate of one or more alkyltrialkoxylsilanes.

9. The hydrophobizing dispersion gel according to claim 1, wherein the branched polyacrylic acid (B) is an interpolymer of acrylic acid which is a polyacrylic acid cross-linked with pentaerythritol triallylether.

10. The hydrophobizing dispersion gel according to claim 1, wherein the components (B) to (E) are each contained independently of one another as an individual substance or as a mixture of various individual substances.

11. A method for producing a hydrophobizing dispersion gel according to claim 1, comprising initially stirring together the components (B) and (C) and up to 20% of the component (E) as well as optionally further additives at temperatures between 0° C. and 50° C. to form an intermediate product and then adding the component (A) and, in steps, the component (D) and also in steps, the remaining fraction of component (E) to the intermediate product, thus forming a multiple dispersion.

12. Use of a hydrophobizing dispersion gel according to claim 1 for hydrophobizing mineral material by application to surfaces.
